(19) United States
(12) Patent Application Publication
(10) Pub. No.: US 2021/0051737 A1
(43) Pub. Date: Feb. 18, 2021

(54) COMMUNICATION RESOURCE SELECTION IN SIDELINK COMMUNICATION

(71) Applicant: QUALCOMM Incorporated, San Diego, CA (US)

(72) Inventors: Gabi SARKIS, San Diego, CA (US); Tien Viet NGUYEN, Bridgewater, NJ (US); Kapil GULATI, Hillsborough, NJ (US)

(21) Appl. No.: 16/992,957

(22) Filed: Aug. 13, 2020

Related U.S. Application Data
(60) Provisional application No. 62/888,397, filed on Aug. 16, 2019.

(51) Int. Cl. H04W 74/08; H04W 52/14; H04W 72/12; H04W 76/14

(52) U.S. Cl. CPC H04W 74/0875; H04W 52/146; H04W 76/14; H04W 72/1247; H04W 74/0816

(57) ABSTRACT

A sidelink device is capable of balancing latency and reliability while accounting for priority in sidelink based communication. A sidelink device determines an exclusion parameter for excluding communication resources for transmitting a data packet over a sidelink channel. The sidelink device selects, based on the exclusion parameter, communication resources for an initial transmission of the data packet in a first contention window (CW). The sidelink device transmits the data packet using the communication resources selected for the initial transmission in the first CW. The sidelink device selects, based on the exclusion parameter, communication resources for a retransmission for the data packet in a second CW after the first CW. The sidelink device transmits the data packet using the communication resources selected for the retransmission in the second CW.

### PRIORITY CLAIM

This application claims priority to and the benefit of provisional patent application No. 62/888,397 filed in the United States Patent and Trademark Office on Aug. 16, 2019, the entire content of which is incorporated herein by reference as if fully set forth below in its entirety and for all applicable purposes.

### TECHNICAL FIELD

The technology discussed below relates generally to wireless communication networks, and more particularly, to resource selection in vehicle-to-everything communications. Some embodiments and techniques enable and provide communication devices, methods, and systems with resource selection features capable of balancing latency and reliability while accounting for the priority of the transmission.

### INTRODUCTION

Wireless communication devices, sometimes referred to as user equipment (UE), may communicate with a base station or may communicate directly with another UE. When a UE communicates directly with another UE, the communication is referred to as device-to-device (D2D) or sidelink communication. In particular use cases, a UE may be a wireless communication device, such as a portable cellular device, or may be a vehicle, such as an automobile, a drone, or may be any other connected devices. When the UE is a vehicle, such as an automobile, the D2D communication may be referred to as vehicle-to-everything (V2X) communication. Some examples of vehicle-to-everything (V2X) include vehicle-to-vehicle (V2V), vehicle-to-infrastructure (V2I), vehicle-to-network (V2N), and vehicle-to-pedestrian (V2P). Vehicle-to-everything communication and particularly, V2V communication may be used in various applications, for example, collision avoidance and autonomous driving.

As the demand for V2X communication continues to increase, research and development continue to advance V2X communication technologies not only to meet the growing demand for V2X communication, but to advance and enhance the user experience with V2X applications.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Embodiments and techniques are disclosed to enable and provide communication devices, methods, and systems with resource selection features capable of balancing latency and reliability while accounting for priority in sidelink or vehicle-to-everything (V2X) communication.

One aspect of the disclosure provides a method of wireless communication at a user equipment (UE). The UE determines an exclusion parameter for excluding communication resources for transmitting a data packet over a sidelink channel. The UE selects, based on the exclusion parameter, communication resources for an initial transmission of the data packet in a first contention window (CW). The UE transmits the data packet using the communication resources selected for the initial transmission in the first CW. The UE selects, based on the exclusion parameter, communication resources for a retransmission for the data packet in a second CW after the first CW. The UE transmits the data packet using the communication resources selected for the retransmission in the second CW.

Another aspect of the disclosure provides a user equipment (UE) for wireless communication. The UE includes a communication interface configured for wireless communication, a memory, and a processor operatively coupled with the communication interface and the memory. The processor is configured to determine an exclusion parameter for excluding communication resources for transmitting a data packet over a sidelink channel. The processor is further configured to select, based on the exclusion parameter, communication resources for an initial transmission of the data packet in a first contention window (CW). The processor is further configured to transmit the data packet using the communication resources selected for the initial transmission in the first CW. The processor is further configured to select, based on the exclusion parameter, communication resources for a retransmission for the data packet in a second CW after the first CW. The processor is further configured to transmit the data packet using the communication resources selected for the retransmission in the second CW.

Another aspect of the disclosure provides a user equipment (UE) for wireless communication. The UE includes means for determining an exclusion parameter for excluding communication resources for transmitting a data packet over a sidelink channel. The UE further includes means for selecting, based on the exclusion parameter, communication resources for an initial transmission of the data packet in a first contention window (CW). The UE further includes means for transmitting the data packet using the communication resources selected for the initial transmission in the first CW. The UE further includes means for selecting, based on the exclusion parameter, communication resources for a retransmission for the data packet in a second CW after the first CW. The UE further includes means for transmitting the data packet using the communication resources selected for the retransmission in the second CW.

Another aspect of the disclosure provides a computer-readable storage medium stored with executable code for wireless communication. The executable code causes a user equipment (UE) to determine an exclusion parameter for excluding communication resources for transmitting a data packet over a sidelink channel. The executable code further causes the UE to select, based on the exclusion parameter, communication resources for an initial transmission of the data packet in a first contention window (CW). The executable code further causes the UE to transmit the data packet using the communication resources selected for the initial transmission in the first CW. The executable code further causes the UE to select, based on the exclusion parameter, communication resources for a retransmission for the data packet in a second CW after the first CW. The executable code further causes the UE to transmit the data packet using the communication resources selected for the retransmission in the second CW.

Various method, system, device, and apparatus embodiments may also include additional features. For example, the exclusion parameter can include multiple sets of exclusion parameters for respective priority levels of sidelink communication. In some examples, the multiple sets of exclusion parameters can include a first set of exclusion parameters associated with a first priority level of sidelink communication and a second set of exclusion parameters associated with a second priority level of sidelink communication that is higher than the first priority level. The second set of exclusion parameters are configured to exclude less communication resources for sidelink communication than communication resources excluded by the first set of exclusion parameters.

In some examples, prior to the initial transmission, a UE can monitor for a resource reservation of a transmission of a communication device that overrides the initial transmission.

In some examples, the exclusion parameter can include a distance parameter configured to exclude communication resources reserved by a communication device based on a distance between the UE and the communication device. In some examples, the exclusion parameter can include a signal power parameter configured to exclude communication resources reserved by the communication device based on a signal power of the communication device.

In some examples, the communication resources for the initial transmission can include available resources that are not excluded by at least one of the distance parameter or the signal power parameter. In some examples, selecting the communication resources for the initial transmission can include determining that no communication resource is available for the initial transmission based on at least one of the distance parameter or the signal power parameter, and adjusting at least one of the distance parameter or the signal power parameter to increase an amount of communication resources available for the initial transmission.

In some examples, selecting the communication resources for the initial transmission can include determining that no communication resource is available for the initial transmission based on at least one of the distance parameter or the signal power parameter, and selecting communication resources reserved for a transmission with a priority level lower than the initial transmission.

In some examples, selecting the communication resources for the initial transmission can include determining that no communication resource is available for the initial transmission based on at least one of the distance parameter or the signal power parameter; and selecting communication resources for the initial transmission from available resources in a later contention window (CW) after the first CW.

In some examples, selecting the communication resources for the retransmission can include selecting communication resources from available resources that are not excluded by at least one of the distance parameter or the signal power parameter. In some examples, selecting the communication resources for the retransmission can include ranking the available resources into a plurality of resource reservation ranks ranging from a highest rank to a lowest rank, and selecting the communication resources starting from the highest rank. In some examples, the plurality of resource reservation ranks can include a first rank associated with free communication resources, a second rank associated with communication resources reserved for transmissions that have lower priority than the retransmission, and a third rank associated with communication resources reserved by a communication device for transmissions with a same priority of the retransmission.

In some examples, selecting the communication resources for the initial transmission can include selecting earliest available communication resources in the first CW or randomly selecting available communication resources in the first CW. In some examples, selecting the communication resources for the retransmission can include selecting earliest available communication resources in the second CW or randomly selecting available communication resources in the second CW.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a conceptual illustration of an example of a vehicle-to-everything (V2X) wireless communication network according to some aspects.

FIG. 4 is a schematic illustration of an organization of wireless resources in an air interface utilizing orthogonal frequency divisional multiplexing (OFDM) according to some aspects.

FIG. 5 is a diagram illustrating an example of a slot for sidelink communication according to some aspects.

FIG. 6 is a diagram illustrating an exemplary sidelink transmission using a plurality of contention windows according to an aspect

FIG. 7 is a diagram illustrating another exemplary sidelink transmission using a plurality of contention windows according to an aspect.

FIG. 8 is a flow chart illustrating an exemplary process for selecting resources for sidelink transmission according to some aspects.

FIG. 9 is a flow chart illustrating an exemplary process for determining parameter values used for selecting sidelink resources according to some aspects.

FIG. 10 is a diagram illustrating a sliding look-back window from a current contention window according to some aspects.

FIG. 11 is a flow chart illustrating an exemplary process for selecting communication resources for an initial sidelink transmission according to some aspects.

FIG. 12 is a flow chart illustrating an exemplary process for selecting communication resources for a retransmission of a data packet according to some aspects.

FIG. 13 is a block diagram conceptually illustrating an example of a hardware implementation for a user equipment according to some aspects.

FIG. 14 is a flow chart illustrating an exemplary process for transmitting a data packet over a sidelink channel according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

Aspects of the present disclosure are directed to devices, methods, and systems using a distributed resource selection scheme for sidelink communication. Examples of sidelink communication are vehicle-to-everything (V2X) communication and device-to-device (D2D) communication. In some aspects of the disclosure, a user equipment uses a look-back procedure to determine a plurality of exclusion parameters that are used to select communication resources for sidelink transmission while taking account of a priority of transmission.

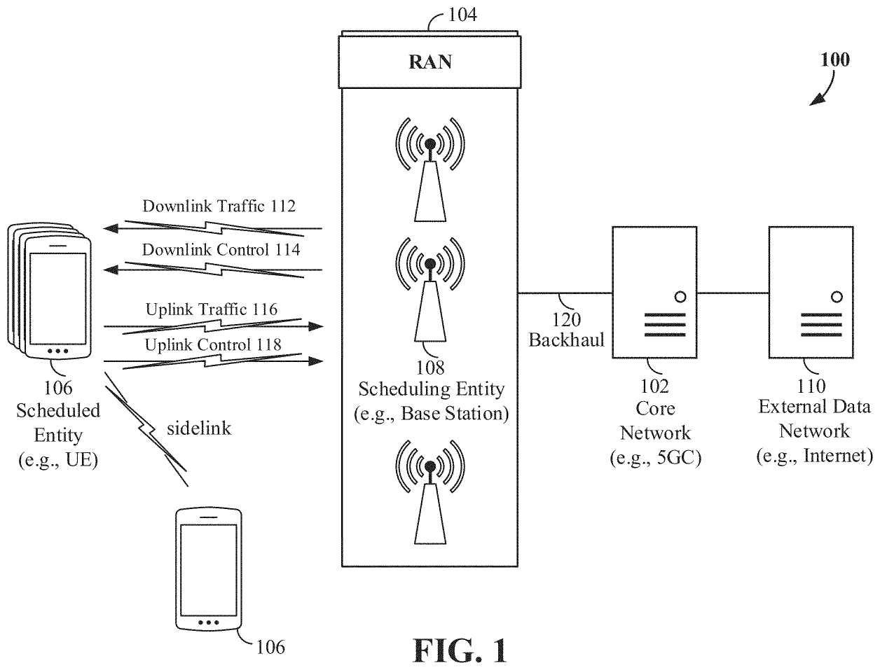

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and user equipment (UE) 106. By virtue of the wireless communication system 100, a UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus, an automobile, and a vehicle) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled. In such arrangements, a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108. In some aspects of the disclosure, two UEs 106 may communicate with each other using D2D or sidelink communication without using resources scheduled by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

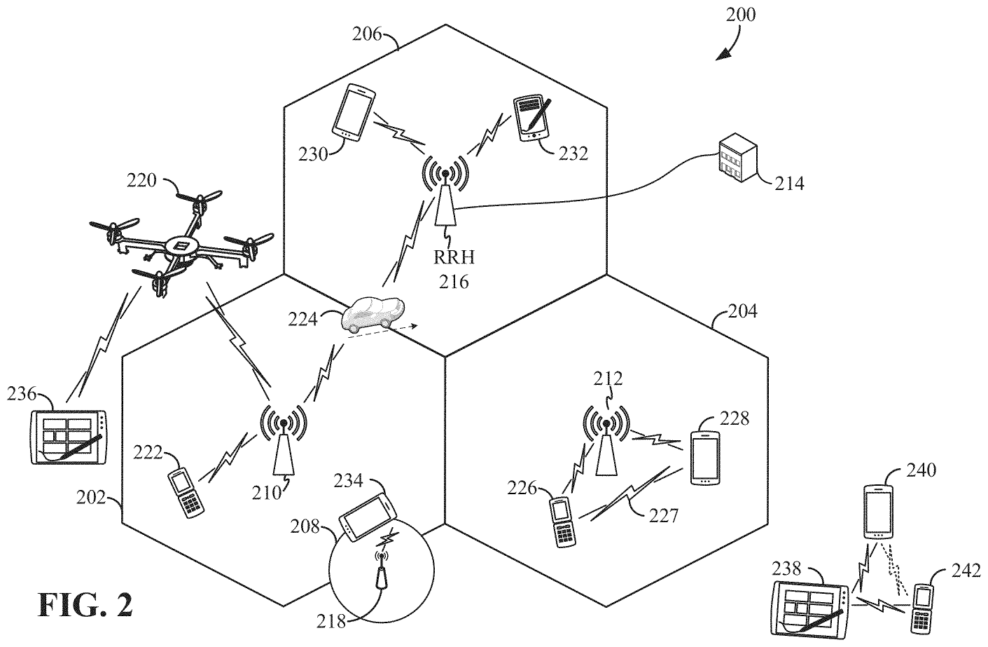

FIG. 2 is a diagram illustrating a radio access network (RAN) 200 according to some aspects of the disclosure. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. A mobile network node may be implemented in various other manners with items capable of movement, and implementations may include many or a plurality of mobile network nodes. For example, the quadcopter 220 may operate within cell 202 by communicating with base station 210. And there may be numerous other airborne (e.g., drone or balloons), stationary (e.g., traffic signals, roadway devices, safety devices, or mobile items (e.g., cars, bikes, pedestrians).

In a further aspect of the RAN 200, UEs can communicate using sidelink, D2D, or V2X signals without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), vehicle-to-vehicle (V2V) network, vehicle-to-everything (V2X), and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

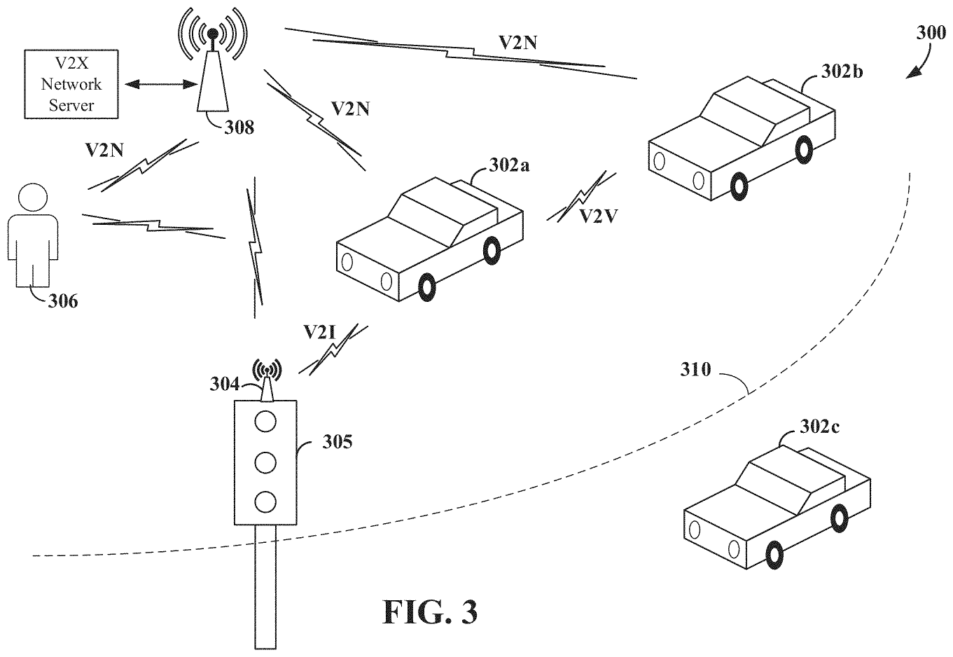

FIG. 3 illustrates an example of a V2X wireless communication network 300. A V2X network can connect vehicles 302a, 302b, and 302c to each other (vehicle-to-vehicle (V2V)), to roadway infrastructure 304/305 (vehicle-to-infrastructure (V2I)), to pedestrians/cyclists 306 (vehicle-to-pedestrian (V2P)), and/or to the network 308 (vehicle-to-network (V2N)) using D2D or sidelink communication.

A V2I transmission may occur between a vehicle (e.g., vehicle 302a) and a roadside unit (RSU) 304, which may be coupled to various infrastructure 305, such as a traffic light, building, streetlight, traffic camera, tollbooth, or other stationary object. In some aspects, the RSU 304 may act as a base station enabling communication between vehicles 302a and 302b, between vehicles 302a/302b and the RSU 304, and between vehicles 302a/302b and mobile devices used by pedestrians/cyclists 306. The RSU 304 may exchange sidelink data (e.g., V2X data) with other RSUs 304 and distribute the sidelink data to V2X connected vehicles 302a/302b and pedestrians 306. The sidelink data may be gathered from the surrounding environment such as a connected traffic camera or traffic light controller, V2X connected vehicles 302a/302b, and mobile devices 306 of pedestrians/cyclists. V2N communication may utilize traditional cellular links to provide cloud services to a V2X device (e.g., within a vehicle 302a/302b or RSU 304, or on a pedestrian 306) for latency-tolerant use cases. For example, V2N may enable a V2X network server to broadcast messages (e.g., weather, traffic, or other information) to V2X devices over a wide area network and may enable V2X devices to send unicast messages to the V2X network server. In addition, V2N communication may provide backhaul services for RSUs 304.

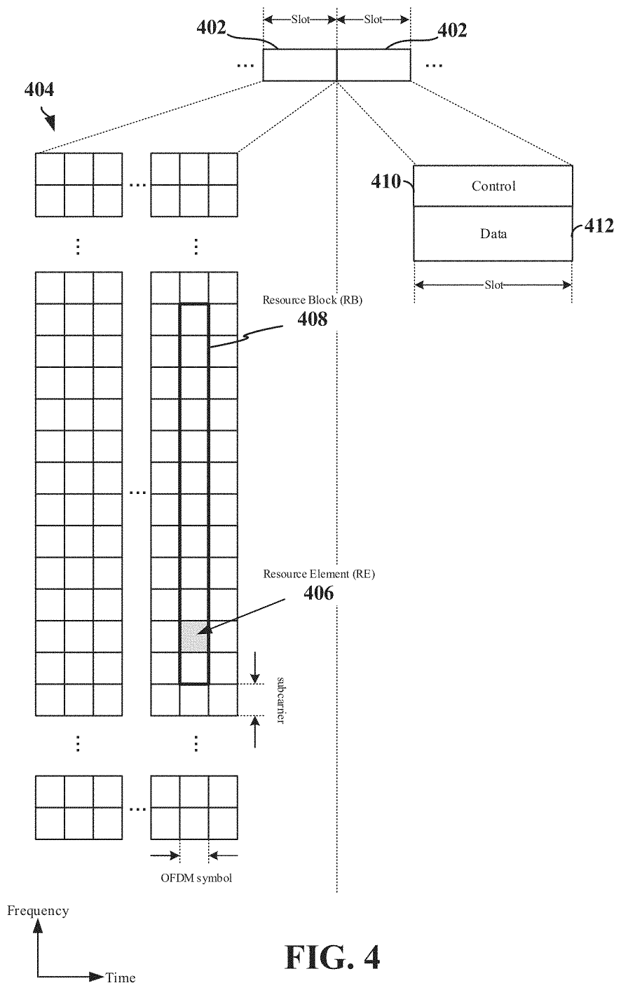

Various aspects of the present disclosure will be described with reference to an OF-DM waveform, schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an exemplary slot 402 is illustrated, showing an OFDM resource grid. However, as those skilled in the art will readily appreciate, the PHY transmission structure for any particular application may vary from the example described here, depending on any number of factors. Here, time is in the horizontal direction with units of OF-DM symbols; and frequency is in the vertical direction with units of subcarriers.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

Scheduling of UEs or sidelink devices for downlink, uplink, or sidelink transmissions typically involves scheduling one or more resource elements 406 within one or more sub-bands. Thus, a UE or sidelink device generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE.

In this illustration, the RB 408 is shown as occupying less than the entire bandwidth of the slot 402, with some subcarriers illustrated above and below the RB 408. In a given implementation, the slot 402 may have a bandwidth corresponding to any number of one or more RBs 408. Further, in this illustration, the RB 408 is shown as occupying less than the entire duration of the slot 402, although this is merely one possible example.

In some examples, a slot may be defined according to a specified number of OF-DM symbols with a given cyclic prefix (CP) length. For example, a slot may include 14 OFDM symbols and each symbol may contain a nominal CP. Additional examples may include mini-slots having a shorter duration (e.g., one to three OFDM symbols). These mini-slots may in some cases be transmitted occupying resources scheduled for ongoing slot transmissions for the same or for different UEs. Any number of resource blocks may be utilized within a slot.

An expanded view of one of the slots 402 illustrates the slot 402 including a control region 410 and a data region 412. In general, the control region 410 may carry control channels, and the data region 412 may carry data channels. Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals, including but not limited to a demodulation reference signal (DMRS) or a sounding reference signal (SRS). These pilots or reference signals may provide for a receiving device to perform channel estimation of the corresponding channel, which may enable coherent demodulation/detection of the control and/or data channels within the RB 408.

In some examples, the slot 402 may be utilized for broadcast, unicast, or multicast/groupcast communication. In sidelink or V2X networks, a broadcast communication may refer to a point-to-multipoint transmission by one sidelink device (e.g., a vehicle, roadside unit (RSU), UE on a pedestrian/cyclist, or other V2X device) to other sidelink devices. A unicast communication may refer to a point-to-point transmission by one sidelink device (e.g., a vehicle, roadside unit (RSU), UE on a pedestrian/cyclist, or other V2X device) to a single other sidelink device. A multicast or groupcast communication may refer to a transmission from a sidelink device to a selected group of sidelink devices.

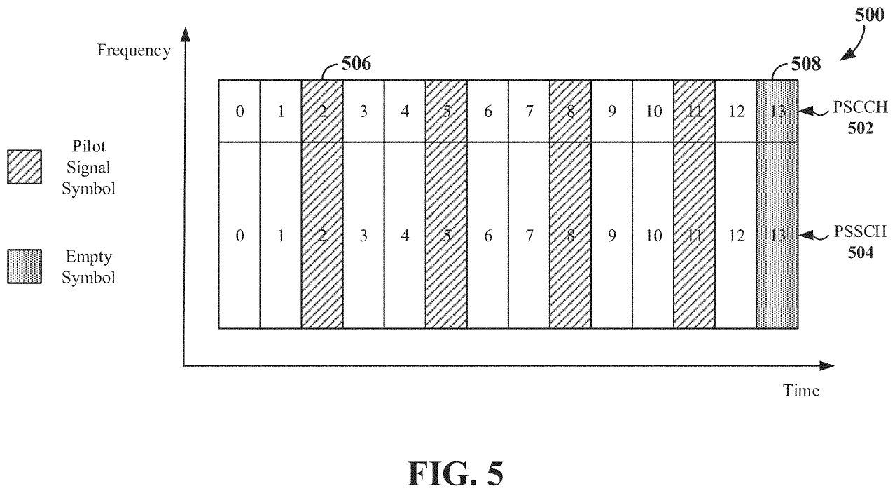

In an example, the control region 410 of the slot 402 may include a physical sidelink control channel (PSCCH) including sidelink control information transmitted by a transmitting sidelink device to a set of one or more receiving sidelink devices nearby the transmitting sidelink device. In some examples, the sidelink control information may include synchronization information to synchronize communication by a plurality of sidelink devices on the sidelink channel. In some examples, the sidelink control information may include resource reservation information for sidelink transmission. In some examples, the sidelink control information may include information that indicates the location or distance of the transmitting device. In addition, the sidelink control information may include decoding information for a physical sidelink shared channel (PSSCH) transmitted within the data region 412 of the slot 402. The PSSCH may include sidelink data (e.g., user data or traffic) transmitted by the transmitting sidelink device over the sidelink channel to a receiving sidelink device. An example of the PSCCH and PSSCH are described below in relation to FIG. 5.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 4 are not necessarily all of the channels or carriers that may be utilized between sidelink devices, and those of ordinary skill in the art will recognize that other channels or carriers may be utilized in addition to those illustrated, such as other traffic, control, and feedback channels.

In various aspects of the disclosure, sidelink wireless communications may be transmitted over a sidelink carrier or channel using a spectrum that is time-divided into a plurality of slots. FIG. 5 illustrates an example of a slot 500 that may be utilized to communicate over such a sidelink carrier. In the example shown in FIG. 5, time is illustrated along a horizontal axis, while frequency is illustrated along a vertical axis. In some examples, the slot 500 may correspond to the slot 402 shown in FIG. 4.

The slot 500 includes a control portion 502 including control information and a data portion 504 including data. In the example shown in FIG. 5, the control information is transmitted within a physical sidelink control channel (PSCCH), while the data is transmitted within a physical sidelink shared channel (PSSCH). The PSCCH and PSSCH are separated in frequency, but each occupy the entire duration of the slot 500. In some examples, the PSCCH may occupy two resource blocks (e.g., 24 subcarriers), while the PSSCH may occupy three or more resource blocks, depending on the sidelink resource allocation. In other examples, the PSCCH and PSSCH may have other resource allocations.

In some examples, the control information includes information related to the data of the shared channel, such as a modulation and coding scheme (MCS) utilized for the shared channel. In some examples, the control information includes resource selection or allocation information of the shared channel for the current slot/contention window or next slot(s)/contention window(s). The shared channel data may include user data, such as status information (e.g., position, speed, acceleration, trajectory, etc.) and/or event information (e.g., traffic jam, icy road, fog, pedestrian crossing the road, collision, etc.), and may also include video data captured by a camera on a vehicle or coupled to an RSU. Various symbols within the slot 500 (e.g., symbols 2, 5, 8, and 11 in the example shown of FIG. 5) may carry pilot signal symbols 506 for carrying pilot signals over the sidelink channel. In addition, one or more symbols (e.g., symbol 13 in the example shown in FIG. 5) may be empty symbols 508 that do not carry control, data, or pilot signals.

Sidelink communication may use sidelink resources that are allocated by a scheduling entity (e.g., a base station or gNB) or selected by a transmitting sidelink device without network (e.g., gNB) intervention. For example, a UE may select communication resources (e.g., time and frequency resources) for sidelink communication from certain resources (e.g., V2X resources). These resources may have been pre-allocated for sidelink or V2X communication. In other scenarios, these resources may be pre-existing, discovered, or leveraged by a UE (e.g., if other devices are not using these resources). In some examples, the base station or gNB may transmit sidelink resource allocation information to the UE using semi-static signaling (e.g., RRC signaling), and the UE selects the sidelink resources available for sidelink communication. In this case, the gNB does not select the specific resources actually used by the UE. When the UE needs to perform sidelink communication, it searches for available communication resources from certain resources that have been allocated or available for sidelink communication (e.g., V2X communication). Once the UE finds available resources, the UE can transmit sidelink data (e.g., a sidelink data packet) using a slot similar to slot 500 shown and described in connection with FIG. 5. The control information (e.g., PSCCH) of a sidelink transmission may reserve resources for a subsequent sidelink retransmission or new sidelink transmission.

According to some aspects, a communication resource may be deemed available to a UE even though the resource might be reserved by another UE or device. For example, a reserved resource may be available if the other UE that reserved the resource is physically far away. For example, the physical distance of the other UE is beyond an exclusion distance threshold. The resource may be available if the signal power from the other UE that reserved the resource is weak or less than a threshold. For example, if the reference signal received power (RSRP) of the signal from the other UE is below a predetermined threshold, the resource may be available. In some examples, the communication resource may be available if the transmission of the other UE has lower priority than the current transmission. By leveraging unused or undesired resources, a UE can efficiently leverage available resources for communication.

In sidelink communication, a UE may need to transmit information or data to another device for communication purposes. Data may be transferred via one or more data packets. In some scenarios, a data packet may have an associated packet delay budget (PDB). A PDB may limit a maximum packet transfer delay of a data packet. Different data packets may have different PDBs. In some scenarios, a UE may transmit a data packet in an initial/first transmission (Tx0) followed by one or more retransmissions of the packet. The number of retransmissions may be specified in a corresponding sidelink communication standards and/or configured by a UE and/or network during operation. Original transmissions and/or retransmissions (e.g., those by a UE) may need to occur in certain time periods or contention windows according to some aspects. The transmitting device determines available resources for the transmission in a contention window (CW).

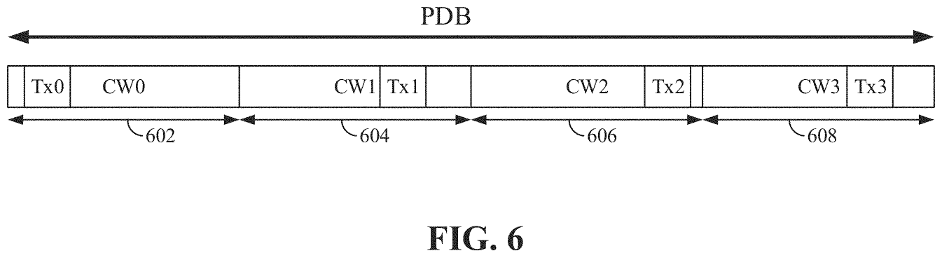

FIG. 6 is a drawing illustrating exemplary data packet transmissions in a plurality of contention windows according to an aspect of the disclosure. In this example, a UE transmits a data packet using a first transmission (Tx0) and three retransmissions (Tx1, Tx2, and Tx3) in their respective contention windows 602, 604, 606, and 608 (illustrated as CW0, CW1, CW2, and CW3 in FIG. 6). In this case, the contention windows are fixed in time within the PDB of the data packet. In one example, the duration of a contention window (CW) may be defined by equation (1) below.

CW=min(PDB, HARQ Budget)/numTx (1)

In equation (1), PDB is the packet delay budget, HARQ Budget is the maximum time between transmissions for HARQ combining, and numTX is the number of transmissions (first transmission and retransmissions) for each data packet. In each CW, the UE selects available resources for the sidelink transmission in the CW Timing of one or more sidelink transmissions in each contention window may change depending on the resources selected by the UE for that particular CW. For example, Tx0, Tx1, Tx2 and Tx3 occur in different time points of their respective contention windows (CW0, CW1, CW2, and CW3). Tx0 occurs in an early part of CW0, while Tx1, Tx2, and Tx3 each occur in later parts of the respective CW.

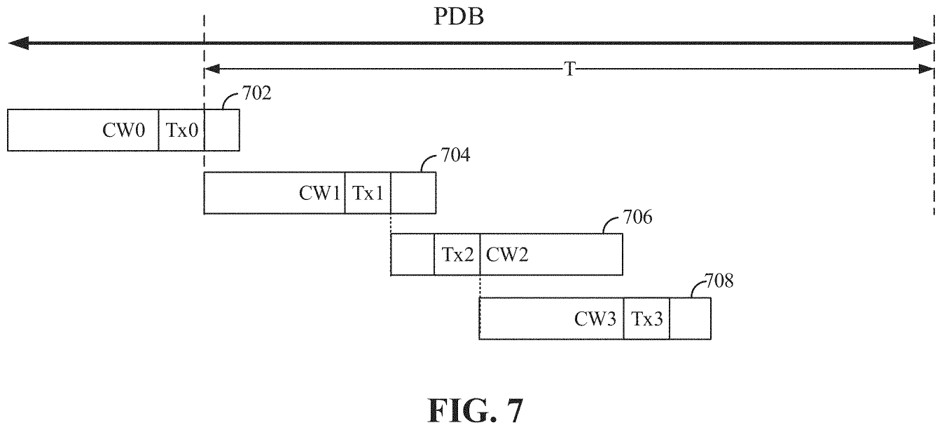

FIG. 7 is a drawing illustrating another exemplary data packet transmission approach according to another sidelink communications aspect of the disclosure. In this example, a UE transmits a data packet in a first/initial transmission (Tx0) in a first contention window (CW0) 702 and three retransmissions (Tx1, Tx2, and Tx3) in respective contention windows (CW1, CW2, and CW3). Different from the example of FIG. 6, the contention window (e.g., CW1, CW2, and CW3) of a retransmission is not fixed in time and can start as soon as a previous sidelink transmission (e.g., Tx0, Tx1, and Tx2) is completed. In some examples, the UE may adjust the length of the CW after each transmission. For example, after Tx0 is completed, the UE may adjust CW1, CW2 and/or CW3 to fill the remaining time T of the PDB after Tx0. Similarly, after Tx1, the UE may adjust CW2 and CW3 to fill the remaining time of the PDB after Tx1. Similarly, after Tx2, the UE may adjust CW3 to fill the remaining time of PDB after Tx2.

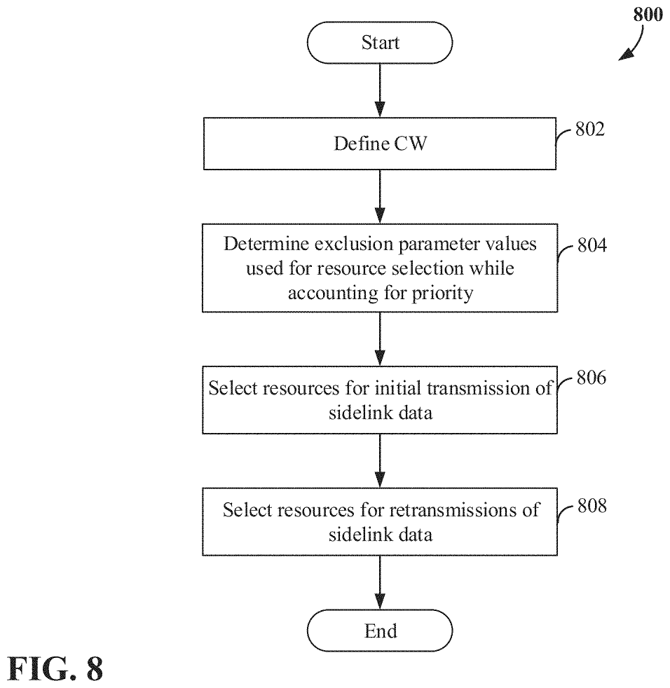

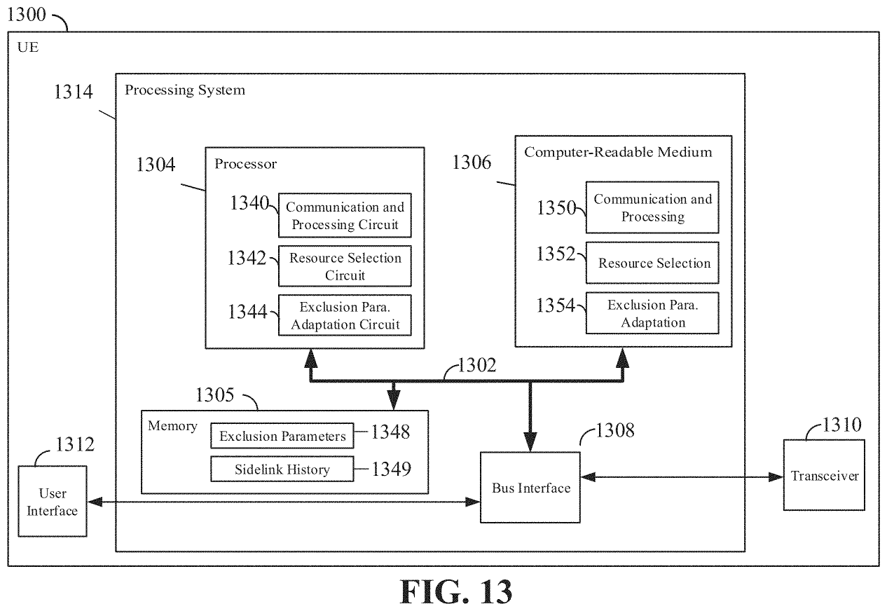

FIG. 8 is a flow chart illustrating an exemplary process 800 for selecting communication resources for sidelink transmission according to some aspects. As described below, some or all illustrated features may be omitted in a particular implementation within the scope of the present disclosure, and some illustrated features may not be required for the implementation of all embodiments. In some examples, the process 800 may be carried out by a UE (e.g., a UE as discussed herein having a variety of features) or scheduled entity 1300 illustrated in FIG. 13. In some examples, the process 800 may be carried out by any suitable apparatus or means for carrying out the functions or algorithm described below.

At block 802, a UE defines a CW for sidelink transmission. For example, the UE may use equation (1) above to determine the duration of a CW for a first/initial transmission (Tx0) based on a known or predetermined PDB and the number of intended retransmissions. For example, the UE may transmit a packet using up to four transmissions that include the initial transmission (Tx0) and three retransmissions (Tx1, Tx2, and Tx3).

At block 804, a UE can determine one or more values of exclusion parameters. These exclusion parameters, according to some aspects, can be used for selecting communication resources in a CW for sidelink transmission. For example, the exclusion parameters may include an exclusion distance and/or exclusion power for excluding resources reserved by other devices (e.g., UEs and vehicles). For example, according to some aspects, a UE may select one or more resources (e.g., time and frequency resources) that are reserved or pre-configured for use by another device (a second device). Such a selection may occur if the second device (e.g., vehicle 302c) is at a distance away from the UE (e.g., vehicle 302a or 302b) beyond an exclusion distance 310 or threshold. An exclusion distance may generally refer to a distance beyond which sidelink communications are unlikely to occur or be successful. In one example, the UE (e.g., vehicle 302a) may select resources that are reserved by another device (e.g., vehicle 302c) if the signal power (e.g., RSRP) of the other device is less than the exclusion power considered at the UE.

In some examples, the UE may support multiple sidelink priority levels. Sidelink communication may have different priority levels based on, for example, desired latency targets and importance of the communication (e.g., emergency information). In some examples, the UE may determine different sets of exclusion parameters (e.g., exclusion distance and exclusion power) for each priority level. In some examples, a sidelink transmission with a higher priority level may use resources that are allocated or selected by another sidelink transmission with a lower priority level. In some examples, an exclusion distance for a higher priority level will decrease, and an exclusion power for a higher priority level will increase. In some aspects, the exclusion parameters may include velocity, location, and/or UE type. Some examples of UE type may include vehicle, bike, and pedestrian. For example, the UE may determine the priority level of a sidelink transmission based on the velocity, location, and/or UE type of the device.

At block 806, the UE selects sidelink communication resources for a first/initial transmission of a data packet. For example, the UE may select certain available time-frequency resources from a sidelink communication resource pool (e.g., RB 408) that has been allocated by a scheduling entity (e.g., gNB) or predetermined for sidelink communication. For example, the UE may select one or more resources based on the sidelink resource exclusion parameters determined in block 804. If the UE supports multiple sidelink priority levels, the UE uses the set of parameter values corresponding to the priority level of the current sidelink transmission.

At block 808, the UE selects sidelink resources for the retransmissions of the data packet. For example, the UE may select one or more resources based on the sidelink resource exclusion parameters determined in block 804 while taking account of the priority of the retransmission. If the UE supports multiple sidelink priority levels, the UE uses the set of parameter values corresponding to the priority level of the current sidelink retransmission.

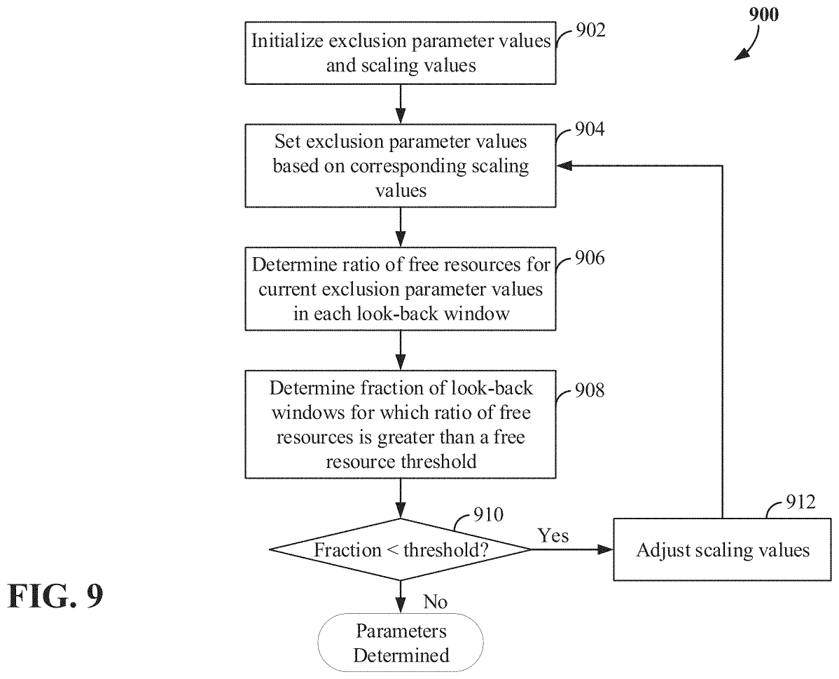

FIG. 9 is a flow chart illustrating an exemplary process 900 for determining exclusion parameter values used for selecting sidelink resources according to some aspects. As described below, some or all illustrated features may be omitted in a particular implementation within the scope of the present disclosure, and some illustrated features may not be required for the implementation of all embodiments. In some examples, the process 900 may be carried out by a UE or scheduled entity 1300 illustrated in FIG. 13. In some examples, the process 900 may be carried out by any suitable apparatus or means for carrying out the functions or algorithm described below. For example, the UE may use the process 900 to determine the exclusion distance and exclusion power for use in the process 800 described in connection with FIG. 8 above.

At block 902, the UE may initialize certain exclusion parameters and their scaling values used for adjusting the exclusion parameters during the process. For example, the exclusion parameters may include an exclusion distance (CE) and an exclusion power (RSRP). The UE may adjust the values of these parameters using equations (2) and (3) during this process.

CE=CE_thres×CE_scaling (2)

RSRP=RSRP_thres−RSRP_scaling (3)

In equation (2), CE_thres is an exclusion distance threshold, and CE_scaling is a scaling value. In equation (3), RSRP_thres is an exclusion power threshold, and RSRP_scaling is a scaling value. CE_step and RSRP_step may be used to adjust CE_scaling and RSRP_scaling when needed. For example, the UE may initialize CE_thres, CE_scaling, RSRP_thres, and RSRP_scaling to their respective predetermined initial values. In one example, the UE may initialize CE_scaling to 1 and RSRP_scaling to 0 dB. In one example, the UE may initialize CE_step to 0.1 and RSRP_step to 3 dB.

At block 904, the UE sets the values of the exclusion parameters (CE and RSRP) based on their respective scaling values as set forth above in equations (2) and (3). Initially, CE_scaling may be 1, and RSRP_scaling may be 0 dB; therefore, the exclusion parameters are unchanged from their respective initial values. In other examples, CE_scaling and RSRP_scaling may have other initial values.

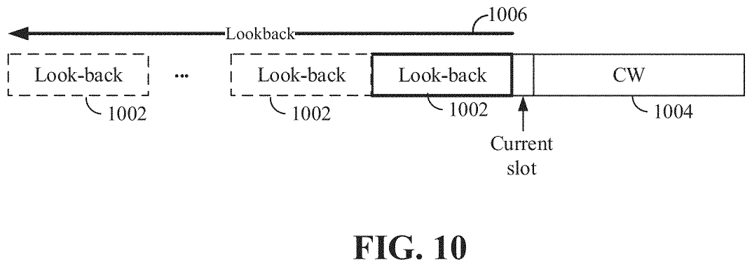

At block 906, the UE determines a ratio of free communication resources in each look-back window based on the current exclusion parameter values. FIG. 10 illustrates a sliding look-back window 1002 from a current contention window 1004. For example, the contention window 1004 may the same as the first contention window CW0 shown and described in connection with FIGS. 6 and 7. The duration of the look-back window 1002 may be the same as the contention window 1004 or any predetermined duration. The look-back time 1006 may be a predetermined time period. For example, the look-back time may be determined as [current_slot−N×CW_duration, current_slot−1]. Current _slot is the starting time point of the current contention window 1004. CW_duration is contention window duration. N is a positive integer that can be set to a predetermined value (e.g., N=100). The look-back window moves back in time in a predetermined step (e.g., a slot or CW_duration). For each step, the UE determines the free resources available for sidelink transmission in that instant of the look-back window based on the current exclusion parameter values. In one example, if the UE looks back N look-back windows, the UE determines N ratios (e.g., R₀, R₁, R₂, . . . R_{N}). For example, the UE may keep a history of sidelink resource utilization in a memory or storage. The history (e.g., sidelink history 1349) may store the distance, location, and/or signal power of all other sidelink devices detected by the UE during the look-back time or look-back window. In sidelink communication, a device may indicate its distance and/or location in its control information transmission (e.g., PSCCH). In some examples, the UE may use a ranging operation to determine the distance and/or location of another sidelink device. In a ranging operation, the UE may transmit and/or receive ranging signals to and from another device to determine the distanced and/or location of the other device.

At block 908, the UE determines a fraction of look-back windows for which the ratio of free resources is greater than a free resource threshold (e.g., 20% or any suitable threshold). In one example, the UE may use one hundred look-back window instances in block 906, and 10 out of the 100 look-back window instances have ratios of free resources more than the free resource threshold. In this case, the fraction of look-back windows for which the ratio of free resources is greater than the free resource threshold is 10%. At decision block 910, the UE determines if the fraction is less than a predetermined threshold (e.g., 5%). If the fraction is not less than the predetermined threshold, the exclusion parameters (CE and RSRP) are determined based on their current values.

At block 912, if the fraction is less than the predetermined threshold, the UE may adjust the exclusion distance threshold (CE_thres) and exclusion power threshold (RSRP_thres) using equations (4) and (5). Increasing RSRP_scaling and/or decreasing CE_scaling allows the UE to consider more resources as available.

RSRP_scaling=RSRP_scaling+RSRP_step (4)

CE_scaling=CE_scaling−CE_step (5)

In some examples, the UE may support multiple sidelink priority levels. In that case, the UE may repeat the process 900 to determine different exclusion parameter (CE and RSRP) values for each priority level. For example, the CE and RSRP values for a higher priority level may increase the available resources for selection than that of a lower priority level. In one aspect, the CE value of a higher priority level may be smaller than the CE value of a lower priority level. In one aspect, the RSRP value of a higher priority level may be larger than the RSRP value of a lower priority level. During resource selection, the UE uses the exclusion parameter values corresponding to the priority level of the sidelink transmission. If the UE does not support or use priority for sidelink communication, the UE may determine one set of parameter values for all priority levels.

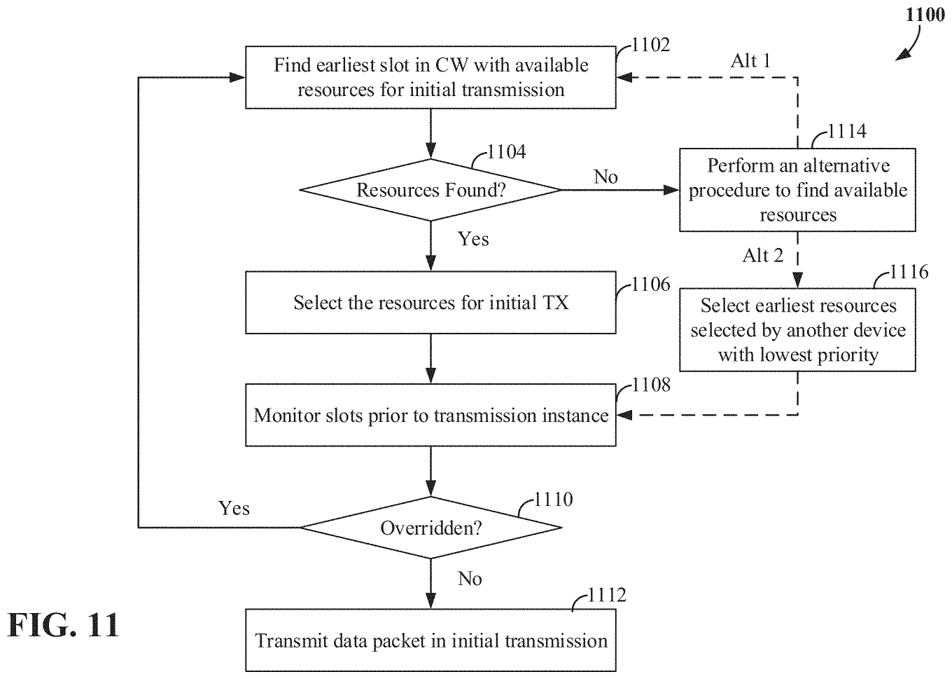

FIG. 11 is a flow chart illustrating an exemplary process 1100 for selecting communication resources for transmitting a data packet in an initial sidelink transmission according to some aspects. As described below, some or all illustrated features may be omitted in a particular implementation within the scope of the present disclosure, and some illustrated features may not be required for the implementation of all embodiments. In some examples, the process 1100 may be carried out by a UE or scheduled entity 1300 illustrated in FIG. 13. In some examples, the process 1100 may be carried out by any suitable apparatus or means for carrying out the functions or algorithm described below. In one example, the UE may use the process 1100 to select communication resources for an initial sidelink transmission of a data packet in the process 800 shown and described in connection with FIG. 8 above.

At block 1102, the UE finds the earliest slot in a contention window (CW) that has available resources for a first/initial sidelink transmission of a data packet. For example, the initial transmission may be similar to Tx0 in CW0 as shown and described in connection of FIGS. 6 and 7 above. The UE selects the resources based on the exclusion parameters (e.g., distance and/or RSRP) described above. For example, a resource is available if the resource is not reserved by another sidelink device that is located closer than a distance specified by the distance parameter. For example, a resource is available if the resource is not reserved by another sidelink device that has a signal power greater than the RSRP parameter. The UE may determine the value of the exclusion parameters using the process 900 shown and described in connection with FIG. 9 above. In some examples, if the UE supports sidelink priority levels, the UE uses the parameter values corresponding to the priority level of the current transmission when determining the available resources.

At decision block 1104, the UE determines if communication resources are available in the current contention window for sidelink transmission. If resources are available in the contention window, at block 1106, the UE selects the resources for the initial transmission. For example, the UE may select certain time-frequency resources in the PSSCH of a slot 500 (e.g., FIG. 5) to transmit the data packet in an initial transmission. The UE may transmit a control signal or message in the PSCCH to reserve the selected resources. The UE may also transmit a resource reservation signal or message for the next CW or transmission, for example, in the PSCCH of the slot.

At block 1108, the UE may monitor a predetermined number of slots prior to the transmission instance (e.g., Tx0) to determine if the resource selection is overridden by another sidelink device's resource reservation. For example, the UE may monitor two or more slots before the initial transmission. The UE may consider the resource selection being overridden if another device selects the same resource or a resource that overlaps the UE's selected resources. The UE may determine the other device's resource selection by monitoring and receiving the control information transmission from the other device.

At decision block 1110, if the UE determines that the resource selection is not overridden by another device, at block 1112, the UE may transmit the data packet in an initial transmission using the selected sidelink resources. However, if the UE determines that the resource selection is overridden, the UE may proceed back to block 1102 to repeat the resource selection process described above. In another example, the UE may reselect the resources only if the overriding sidelink transmission has a higher priority than the UE's initial transmission.

Referring back to block 1104, if the UE finds no available resources in the contention window, the UE may use an alternative procedure to find available resources for the initial transmission at block 1114. In one example, the UE may adjust the exclusion parameter values (e.g., reducing distance and/or increasing RSRP) and repeat (Alt 1) the process at block 1102 to find available resources until available resources are found. However, if the UE still cannot find available resources after a predetermined number of attempts, the UE may use another method (Alt 2) described below to find available resources.

In one example, at block 1116, the UE may select the earliest resources selected by another device that has the lowest priority in the contention window, where this “lowest priority” is lower than the priority level of the current initial transmission. The UE may also consider the distance and power (e.g., RSRP) of the other device when selecting the earliest resources available. For example, the UE may avoid selecting the resources reserved by another device that is closer than a threshold distance and/or has a RSRP greater than a threshold value. If the UE still cannot find any available resources for the first transmission, the UE may use another suitable method to find available resources.

In one example, the UE may repeat the process described in connection with block 1102 in another contention window after the current contention window. In one example, the UE may drop or delay the current transmission when no available resource is found in the current contention window.

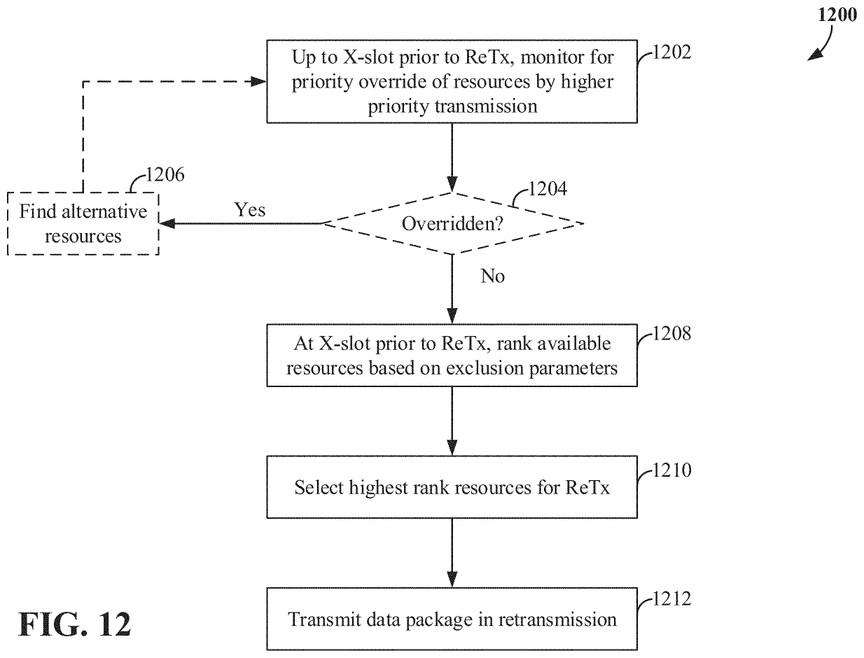

FIG. 12 is a flow chart illustrating an exemplary process 1200 for selecting resources for a retransmission of a data packet according to some aspects. As described below, some or all illustrated features may be omitted in a particular implementation within the scope of the present disclosure, and some illustrated features may not be required for the implementation of all embodiments. In some examples, the process 1200 may be carried out by a UE or scheduled entity 1300 illustrated in FIG. 13. In some examples, the process 1200 may be carried out by any suitable apparatus or means for carrying out the functions or algorithm described below. For example, the UE may use process 1200 to select the resources for a retransmission of a data packet in the process 800 shown and described in connection with FIG. 8 above.

During the initial transmission (e.g., Tx0 in CW0), the UE can transmit control information to reserve communication resources for the retransmission of the data packet in the next CW (e.g., CW1, CW2, CW3). For the retransmission, the UE may reserve the same time-frequency resources within a slot as used in the first transmission. For example, the UE may reserve certain carriers and symbols of a slot for the upcoming retransmission of a data packet or the next transport block.

At block 1202, the UE monitors for priority override of the reserved resources by another device's transmission with higher priority than the UE's current retransmission. The UE may perform the monitoring up to a predetermined number of slots (e.g., up to X slots) prior to the retransmission. In some examples, if the UE does not support priority, the UE may not monitor for priority override before retransmission.

At decision block 1204, if priority is used, the UE determines whether the UE's resource reservation is overridden by a higher priority transmission of another device. If the resource reservation is overridden, at block 1206, the UE finds alternative resources for the retransmission. For example, the UE may use the procedure shown and described in connection with FIG. 11 to find available resources for the retransmission. If the resource reservation is not overridden, the process proceeds to block 1208.

At block 1208, at the X slot prior to the retransmission, the UE ranks the available resources that are found based on the exclusion parameters determined during the initial transmission as shown and described in connection with FIG. 11. The window for selecting the resources may be defined as [current slot+x slot, current slot+x slot+CW]. The available resources may be ranked as shown in Table 1.

| Rank | Resources |
|---|---|
| 1 | Free |
| 2 | Lower priority reservation |
| 3 | Same priority reservation, lower range |

Table 1 illustrates three exemplary ranks. In other aspects, the UE may use more or fewer ranks to classify the available resources. A rank 1 resource has no existing reservation, and the UE may use it freely for retransmission. A rank 2 resource is reserved by another device for a lower priority transmission. A rank 3 resource is reserved by another device for a transmission with the same priority of the UE's current retransmission, but the other device is beyond a certain distance and/or has power (RSRP) below a certain threshold.

At block 1210, the UE selects the retransmission resources based on the rankings of the available resources. For example, the UE may randomly select the resources starting from the highest rank. The UE may prefer higher rank resources than lower ranked resources. At block 1212, the UE transmits the data packet in a retransmission using the selected resources in the corresponding CW (e.g., CW1, CW2, or CW3).

In some examples, for the first or first Y transmissions, the UE may select the earliest available resource as described above in connection with FIG. 11 to reduce packet latency. The value of Y may be specified in the communication standards, configured by the network, determined based on transmission priority, or determined based on the total number of transmissions. If multiple available resources start at the same time, the UE may randomly select among these resources. In some examples, the UE may randomly select the resources from the available resources in the contention window. For the remaining transmissions (i.e., retransmission), the UE may randomly select from the available resources within the contention window. In some examples, for all transmissions (first transmission and retransmissions), the UE may select the earliest available resource within the contention window.

In one example, the size of the contention window may be the same for all transmissions. In one example the size of the contention window may be based on a transmission index that indicates the sequence of the transmissions. For example, the window may be smaller for the initial transmission, and becomes larger for later transmissions. In one example, the UE may recalculate the window size after each transmission for the remaining transmissions. In one example, the window size may be based on the priority of the transmission. For example, the window size is smaller for a high priority transmission than that of a lower priority transmission. In some examples, the UE may use a combination of the above methods to determine the contention window size.

In one example, each contention window may start immediately following the previous transmission. In one example, each contention window may be fixed in time within a packet delay budget (PDB). In one example, the UE may use priority to determine how a contention window starts using one of the methods described above.

FIG. 13 is a block diagram illustrating an example of a hardware implementation for a scheduled entity 1300 employing a processing system 1314. For example, the scheduled entity 1300 may be a user equipment (UE) as illustrated in any one or more of FIGS. 1, 2, and/or 3. In one example, the UE may be capable of sidelink communication (e.g., V2X communication). In one example, the UE may be a V2X device.

The scheduled entity 1300 may be implemented with a processing system 1314 that includes one or more processors 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduled entity 1300 may be configured to perform any one or more of the functions described herein. That is, the processor 1304, as utilized in a scheduled entity 1300, may be used to implement any one or more of the processes and procedures described and illustrated in FIGS. 8-12 and 14.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 communicatively couples together various circuits including one or more processors (represented generally by the processor 1304), a memory 1305, and computer-readable media (represented generally by the computer-readable medium 1306). The bus 1302 may also link various other circuits such as timing sources, peripherals, voltage regulators, and power management circuits, which are well known in the art, and therefore, will not be described any further. A bus interface 1308 provides an interface between the bus 1302 and a transceiver 1310. The transceiver 1310 provides a communication interface or means for communicating with various other apparatus over a transmission medium. Depending upon the nature of the apparatus, a user interface 1312 (e.g., keypad, display, speaker, microphone, joystick) may also be provided. Of course, such a user interface 1312 is optional, and may be omitted in some examples, such as a base station.

The processor 1304 is responsible for managing the bus 1302 and general processing, including the execution of software stored on the computer-readable medium 1306. The software, when executed by the processor 1304, causes the processing system 1314 to perform the various functions described below for any particular apparatus. The computer-readable medium 1306 and the memory 1305 may also be used for storing data (e.g., exclusion parameters 1348 and sidelink communication history 1349) that is manipulated by the processor 1304 when executing software.

One or more processors 1304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1306. The computer-readable medium 1306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1306 may reside in the processing system 1314, external to the processing system 1314, or distributed across multiple entities including the processing system 1314. The computer-readable medium 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1304 may include circuitry configured for various functions. For example, the processor 1304 may include communication and processing circuitry 1340, configured to communicate with another device (e.g., a base station or another UE). In some examples, the communication and processing circuitry 1340 may include one or more hardware components that provide the physical structure that performs processes related to wireless communication (e.g., signal reception and/or signal transmission) and signal processing (e.g., processing a received signal and/or processing a signal for transmission).

In some examples, the communication and processing circuitry 1340 may be configured to generate and transmit a sidelink data packet via the transceiver 1310. In one example, the communication and processing circuitry 1340 may be configured to transmit a sidelink or V2X packet using multiple transmissions (e.g., initial transmission and retransmissions) in a plurality of contention windows. In addition, the communication and processing circuitry 1340 may be configured to receive and process a sidelink data packet via the transceiver 1310. In one example, the communication and processing circuitry 1340 may be configured to receive a sidelink or V2X packet from another UE. The communication and processing circuitry 1340 may further be configured to transmit and receive sidelink or V2X control information and data traffic. The communication and processing circuitry 1340 may further be configured to execute communication and processing software 1350 stored in the computer-readable medium 1306 to implement one or more of the functions described herein.

The processor 1304 may further include resource selection circuitry 1342, configured to select communication resources for wireless communication (e.g., sidelink or V2X communication) while accounting for the priority of the transmission and other transmitting devices. The resource selection circuitry 1342 may further be configured to select communication resources for an initial transmission and retransmissions of a sidelink data packet. The selection may be based on certain exclusion parameters, for example, a distance parameter and a signal power parameter. The exclusion parameters exclude certain communication resources that are reserved by another UE that is within a certain distance and/or has a signal power (e.g., RSRP) greater than a threshold. The resource selection circuitry 1342 may further be configured to execute resource selection software 1352 stored in the computer-readable medium 1306 to implement one or more of the functions described herein.

The processor 1304 may further include exclusion parameter adaptation circuitry 1344, configured to determine, select, adjust, and adapt the exclusion parameters to facilitate communication resource selection for sidelink or V2X transmission. The exclusion parameter adaptation circuitry 1344 may further be configured to take priority of sidelink or V2X transmission into consideration. In some examples, the exclusion parameter adaptation circuitry 1344 may use a sliding look-back window prior to a contention windows (CW) to determine the values of the exclusion parameters, for example, using the procedure shown and described in connection with FIGS. 9 and 10. The exclusion parameter adaptation circuitry 1344 may further be configured to execute exclusion parameter adaptation software 1354 stored in the computer-readable medium 1306 to implement one or more of the functions described herein. The exclusion parameters 1348 may be stored in the memory 1305 or any storage medium (e.g., a computer-readable medium 1306).

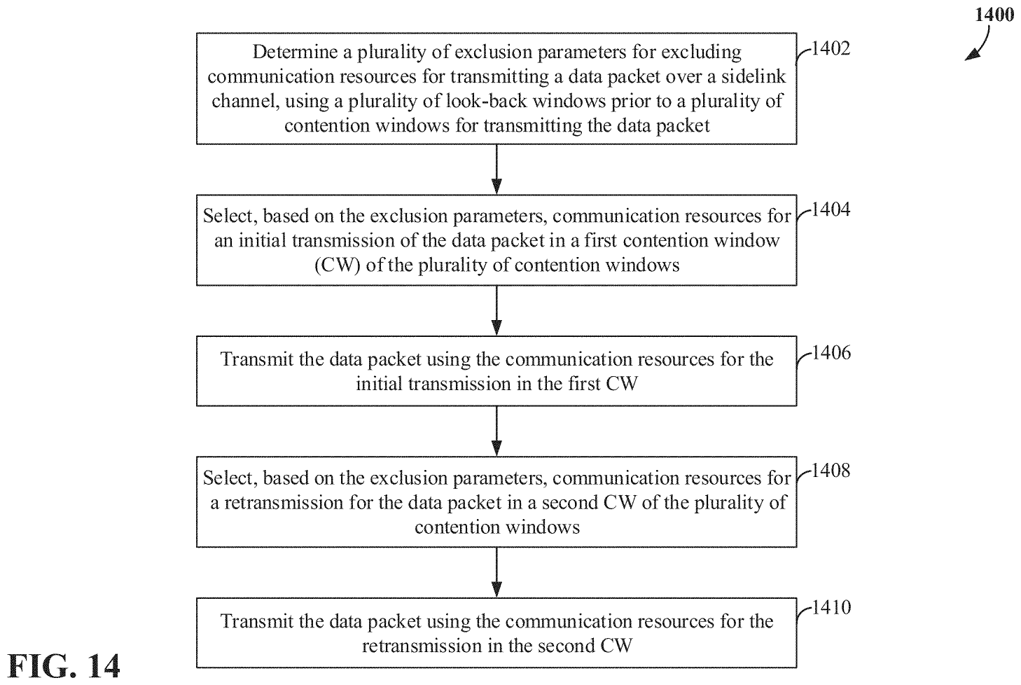

FIG. 14 is a flow chart illustrating an exemplary process 1400 for transmitting a data packet over a sidelink channel according to some aspects. As described below, some or all illustrated features may be omitted in a particular implementation within the scope of the present disclosure, and some illustrated features may not be required for the implementation of all embodiments. In some examples, the process 1400 may be carried out by the user equipment (UE) 1300 illustrated in FIG. 13. In some examples, the process 1400 may be carried out by any suitable apparatus or means for carrying out the functions or algorithm described below.

At block 1402, the UE determines a plurality of exclusion parameters for excluding communication resources for transmitting a data packet over a sidelink channel, using a plurality of look-back windows prior to a plurality of contention windows for transmitting the data packet. For example, the UE may use the parameter adaptation circuitry 1344 to determine the values of the exclusion parameters, for example, a distance parameter (CE) and a power parameter (RSRP) using the processes shown and illustrated in connection with FIGS. 9 and 10. In some examples, the UE may determine multiple sets of exclusion parameters respectively corresponding to different priority levels of sidelink communication.

At block 1404, the UE selects, based on the exclusion parameters, communication resources for an initial transmission of the data packet in a first contention window (CW) of the plurality of contention windows. For example, the first CW may be similar to CW0 shown and described in connection with FIGS. 6 and 7. The UE may use the resource selection circuitry 1342 to select the communication resources for the initial transmission using the process shown and described in connection with FIG. 11. At block 1406, the UE transmits the data packet using the communication resources selected for the initial transmission in the first CW. For example, the UE may use the communication and processing circuitry 1340 to transmit the data packet in the first CW via the transceiver 1310.

At block 1408, the UE selects, based on the exclusion parameters, communication resources for a retransmission for the data packet in a second CW of the plurality of contention windows. For example, the second CW may be similar to CW1, CW2, or CW3 shown and described in connection with FIGS. 6 and 7. The UE may use the resource selection circuitry 1342 to select the communication resources for the retransmission using the process shown and described in connection with FIG. 12. At block 1410, the UE retransmits the data packet using the communication resources selected in the second CW. For example, the UE may use the communication and processing circuitry 1340 to retransmit the data packet in the second CW via the transceiver 1310.

In one configuration, the scheduled entity 1300 includes means for performing the various functions and processes described in relation to FIGS. 5-12 and 14. In one aspect, the aforementioned means may be the processor 1304 shown in FIG. 13 configured to perform the functions recited by the aforementioned means. In another aspect, the aforementioned means may be a circuit or any apparatus configured to perform the functions recited by the aforementioned means.

Of course, in the above examples, the circuitry included in the processor 1304 is merely provided as an example, and other means for carrying out the described functions may be included within various aspects of the present disclosure, including but not limited to the instructions stored in the computer-readable storage medium 1306, or any other suitable apparatus or means described in any one of the FIGS. 1,2, and/or 3, and utilizing, for example, the processes and/or algorithms described herein in relation to FIGS. 8-12 and/or 14.

In some aspects of the disclosure, a sidelink device selects, based on one or more exclusion parameters, communication resources for an initial transmission of a data packet in a first CW of a plurality of contention windows. The sidelink device may consider the priority of the transmission when selecting the communication resources. The sidelink device transmits the data packet using communication resources selected for the initial transmission in the first CW. The sidelink device selects, based on the one or more exclusion parameters, communication resources for a retransmission for the data packet in a second CW of the plurality of contention windows. The sidelink device transmits the data packet using the communication resources selected for the retransmission in the second CW.

The processes shown in FIGS. 5-12 and 14 may include additional aspects, such as any single aspect or any combination of aspects described below and/or in connection with one or more other processes described elsewhere herein.

In a first aspect, a scheduled entity (e.g., a UE) in a wireless communication network may determine multiple sets of exclusion parameters for respective priority levels of sidelink communication.

In a second aspect, the multiple sets of exclusion parameters include a first set of exclusion parameters associated with a first priority level of sidelink communication and a second set of exclusion parameters associated with a second priority level of sidelink communication that is higher than the first priority level. The second set of exclusion parameters are configured to exclude less communication resources for sidelink communication than communication resources excluded by the first set of exclusion parameters.

In a third aspect, the scheduled entity may, prior to the initial transmission, monitor for a resource reservation of a transmission of a communication device that overrides the initial transmission.

In a fourth aspect, the exclusion parameter includes at least one of a distance parameter configured to exclude communication resources reserved by a communication device based on a distance between the UE and the communication device, or a signal power parameter configured to exclude communication resources reserved by the communication device based on a signal power of the communication device.

In a fifth aspect, selecting the communication resources for the initial transmission may include selecting communication resources from available resources that are not excluded by at least one of the distance parameter or the signal power parameter.

In a sixth aspect, selecting the communication resources for the initial transmission may include determining that no communication resource is available for the initial transmission based on at least one of the distance parameter or the signal power parameter, and adjusting at least one of the distance parameter or the signal power parameter to increase an amount of communication resources available for the initial transmission.

In a seventh aspect, selecting the communication resources for the initial transmission may include determining that no communication resource is available for the initial transmission based on at least one of the distance parameter or the signal power parameter, and selecting communication resources reserved for a transmission with a priority level lower than the initial transmission.

In an eighth aspect, selecting the communication resources for the initial transmission may include determining that no communication resource is available for the initial transmission based on at least one of the distance parameter or the signal power parameter, and selecting communication resources for the initial transmission from available resources in a later CW after the first CW.

In a ninth aspect, selecting the communication resources for the retransmission may include selecting communication resources from available resources that are not excluded by at least one of the distance parameter or the signal power parameter.

In a tenth aspect, selecting the communication resources for the retransmission may include ranking the available resources into a plurality of resource reservation ranks ranging from a highest rank to a lowest rank, and selecting the communication resources starting from the highest rank.

In an eleventh aspect, the plurality of resource reservation ranks include a first rank associated with free communication resources, a second rank associated with communication resources reserved for transmissions that have lower priority than the retransmission, and a third rank associated with communication resources reserved by a communication device for transmissions with a same priority of the retransmission.

In a twelfth aspect, selecting the communication resources for the initial transmission includes selecting earliest available communication resources in the first CW or randomly selecting available communication resources in the first CW.

In a thirteenth aspect, selecting the communication resources for the retransmission may include selecting earliest available communication resources in the second CW or randomly selecting available communication resources in the second CW.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-14 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of wireless communication at a user equipment (UE), comprising:
determining an exclusion parameter for excluding communication resources for transmitting a data packet over a sidelink channel;
selecting, based on the exclusion parameter, communication resources for an initial transmission of the data packet in a first contention window (CW);
transmitting the data packet using the communication resources selected for the initial transmission in the first CW;
selecting, based on the exclusion parameter, communication resources for a retransmission for the data packet in a second CW after the first CW; and
transmitting the data packet using the communication resources selected for the retransmission in the second CW.

2. The method of claim 1, comprising:
determining the exclusion parameter using a look-back window prior to the first CW.

3. The method of claim 1, wherein determining the exclusion parameter comprises:
determining multiple sets of exclusion parameters for respective priority levels of sidelink communication.

4. The method of claim 3,
wherein the multiple sets of exclusion parameters comprise a first set of exclusion parameters associated with a first priority level of sidelink communication and a second set of exclusion parameters associated with a second priority level of sidelink communication that is higher than the first priority level, and
wherein the second set of exclusion parameters are configured to exclude less communication resources for sidelink communication than communication resources excluded by the first set of exclusion parameters.

5. The method of claim 1, further comprising:
prior to the initial transmission, monitoring for a resource reservation of a transmission of a communication device that overrides the initial transmission.

6. The method of claim 1, wherein the exclusion parameter comprises at least one of:
a distance parameter configured to exclude communication resources reserved by a communication device based on a distance between the UE and the communication device; or
a signal power parameter configured to exclude communication resources reserved by the communication device based on a signal power of the communication device.

7. The method of claim 6, wherein selecting the communication resources for the initial transmission comprises:
selecting communication resources from available resources that are not excluded by at least one of the distance parameter or the signal power parameter.

8. The method of claim 7, wherein selecting the communication resources for the initial transmission comprises:
determining that no communication resource is available for the initial transmission based on at least one of the distance parameter or the signal power parameter; and
at least one of:
adjusting at least one of the distance parameter or the signal power parameter to increase an amount of communication resources available for the initial transmission;
selecting communication resources reserved for a transmission with a priority level lower than the initial transmission; or
selecting communication resources for the initial transmission from available resources in a later CW after the first CW.

9. The method of claim 6, wherein selecting the communication resources for the retransmission comprises:
selecting communication resources from available resources that are not excluded by at least one of the distance parameter or the signal power parameter.

10. The method of claim 9, wherein selecting the communication resources for the retransmission comprises:
ranking the available resources into a plurality of resource reservation ranks ranging from a highest rank to a lowest rank; and
selecting the communication resources starting from the highest rank.

11. The method of claim 10, wherein the plurality of resource reservation ranks comprise:
a first rank associated with free communication resources;
a second rank associated with communication resources reserved for transmissions that have lower priority than the retransmission; and
a third rank associated with communication resources reserved by a communication device for transmissions with a same priority of the retransmission.

12. The method of claim 1, wherein selecting the communication resources for the initial transmission comprises:
selecting earliest available communication resources in the first CW; or
randomly selecting available communication resources in the first CW.

13. The method of claim 1, wherein selecting the communication resources for the retransmission comprises:
selecting earliest available communication resources in the second CW; or
randomly selecting available communication resources in the second CW.

14. A user equipment (UE), comprising:
a communication interface configured for wireless communication;
a memory; and
a processor operatively coupled with the communication interface and the memory,
wherein the processor is configured to:
determine an exclusion parameter for excluding communication resources for transmitting a data packet over a sidelink channel;
select, based on the exclusion parameter, communication resources for an initial transmission of the data packet in a first contention window (CW);
transmit the data packet using the communication resources selected for the initial transmission in the first CW;
select, based on the exclusion parameter, communication resources for a retransmission for the data packet in a second CW after the first CW; and
transmit the data packet using the communication resources selected for the retransmission in the second CW.

15. The UE of claim 14, wherein the processor is further configured to:
determine the exclusion parameter using a look-back window prior to the first CW for transmitting the data packet.

16. The UE of claim 14, wherein for determining the exclusion parameter, the processor is further configured to:
determine multiple sets of exclusion parameters for respective priority levels of sidelink communication.

17. The UE of claim 16,
wherein the multiple sets of exclusion parameters comprise a first set of exclusion parameters associated with a first priority level of sidelink communication and a second set of exclusion parameters associated with a second priority level of sidelink communication that is higher than the first priority level, and
wherein the second set of exclusion parameters are configured to exclude less communication resources for sidelink communication than communication resources excluded by the first set of exclusion parameters.

18. The UE of claim 14, wherein the processor is further configured to:
prior to the initial transmission, monitor for a resource reservation of a transmission of a communication device that overrides the initial transmission.

19. The UE of claim 14, wherein the exclusion parameter comprises at least one of:
a distance parameter configured to exclude communication resources reserved by a communication device based on a distance between the UE and the communication device; or
a signal power parameter configured to exclude communication resources reserved by the communication device based on a signal power of the communication device.

20. The UE of claim 19, wherein for selecting the communication resources for the initial transmission, the processor is further configured to:
select communication resources from available resources that are not excluded by at least one of the distance parameter or the signal power parameter.

21. The UE of claim 20, wherein for selecting the communication resources for the initial transmission, the processor is further configured to:
determine that no communication resource is available for the initial transmission based on at least one of the distance parameter or the signal power parameter; and
at least one of:
adjust at least one of the distance parameter or signal power parameter to increase an amount of communication resources available for the initial transmission;
select communication resources reserved for a transmission with a priority level lower than the initial transmission; or
select communication resources for the initial transmission from available resources in a later CW after the first CW.

22. The UE of claim 19, wherein for selecting the communication resources for the retransmission, the processor is further configured to:
select communication resources from available resources that are not excluded by at least one of the distance parameter or the signal power parameter.

23. The UE of claim 22, wherein for selecting the communication resources for the retransmission, the processor is further configured to:
rank the available resources into a plurality of resource reservation ranks ranging from a highest rank to a lowest rank; and
select the communication resources starting from the highest rank.

24. The UE of claim 23, wherein the plurality of resource reservation ranks comprise:
a first rank associated with free communication resources;
a second rank associated with communication resources reserved for transmissions that have lower priority than the retransmission; and
a third rank associated with communication resources reserved by a communication device for transmissions with a same priority of the retransmission.

25. The UE of claim 14, wherein for selecting the communication resources for the initial transmission, the processor is further configured to:
select earliest available communication resources in the first CW; or
randomly select available communication resources in the first CW.

26. The UE of claim 14, wherein for selecting the communication resources for the retransmission comprises:
select earliest available communication resources in the second CW; or
randomly select available communication resources in the second CW.

27. A user equipment (UE), comprising:
means for determining an exclusion parameter for excluding communication resources for transmitting a data packet over a sidelink channel;
means for selecting, based on the exclusion parameter, communication resources for an initial transmission of the data packet in a first contention window (CW);
means for transmitting the data packet using the communication resources selected for the initial transmission in the first CW;
means for selecting, based on the exclusion parameter, communication resources for a retransmission for the data packet in a second CW after the first CW; and
means for transmitting the data packet using the communication resources selected for the retransmission in the second CW.

28. The UE of claim 27, comprising:
means for determining the exclusion parameter using a look-back window prior to the first CW.

29. The UE of claim 27, wherein the means for determining the exclusion parameter is configured to:
determine multiple sets of exclusion parameters for respective priority levels of sidelink communication,
wherein the multiple sets of exclusion parameters comprise a first set of exclusion parameters associated with a first priority level of sidelink communication and a second set of exclusion parameters associated with a second priority level of sidelink communication that is higher than the first priority level, and
wherein the second set of exclusion parameters are configured to exclude less communication resources for sidelink communication than communication resources excluded by the first set of exclusion parameters.

30. A computer-readable storage medium stored with executable code for wireless communication, the executable code causing a user equipment (UE) to:
determine an exclusion parameter for excluding communication resources for transmitting a data packet over a sidelink channel;
select, based on the exclusion parameter, communication resources for an initial transmission of the data packet in a first contention window (CW);
transmit the data packet using the communication resources selected for the initial transmission in the first CW;
select, based on the exclusion parameter, communication resources for a retransmission for the data packet in a second CW after the first CW; and
transmit the data packet using the communication resources selected for the retransmission in the second CW.
